(19) United States
(12) Patent Application Publication
(10) Pub. No.: US 2024/0181864 A1
(43) Pub. Date: Jun. 6, 2024

(54) ELECTRIC PASSENGER TRANSPORT VEHICLE

(71) Applicant: KAWASAKI MOTORS, LTD., Akashi-Shi (JP)

(72) Inventors: Kota HIDAKA, Akashi-Shi (JP); Daisuke WATANABE, Akashi-Shi (JP); Daisuke SAEKI, Akashi-Shi (JP); Ryo SEKOGUCHI, Akashi-Shi (JP)

(73) Assignee: KAWASAKI MOTORS, LTD., Akashi-Shi (JP)

(21) Appl. No.: 18/452,638

(22) Filed: Aug. 21, 2023

Related U.S. Application Data
(63) Continuation-in-part of application No. 18/061,016, filed on Dec. 2, 2022, now abandoned.

(51) Int. Cl. B60K 1/04; B62D 25/04; B62D 25/08

(52) U.S. Cl. CPC B60K 1/04; B62D 25/04; B62D 25/08; B60K 2001/0422

(57) ABSTRACT

An electric passenger transport vehicle includes: a car body including a floor; a first seat located at a distance above the floor; a second seat located at a distance behind the first seat; and batteries aligned between the first seat and the floor in a vehicle-width direction, all the batteries at least partially overlapping one another when viewed from a side along the vehicle-width direction.

### BACKGROUND OF THE INVENTION

### Field of the Invention

The present disclosure relates to an electric passenger transport vehicle.

### Description of the Background Art

WO2004/067327 discloses a golf cart including seats.

### SUMMARY

This electric passenger transport vehicle is an electric passenger transport vehicle including: a car body including a floor; a first seat located at a distance above the floor; a second seat located at a distance behind the first seat; and batteries aligned between the first seat and the floor in a vehicle-width direction, all the batteries at least partially overlapping one another when viewed from a side along the vehicle-width direction.

Wide leg space is easily reserved in this electric passenger transport vehicle.

The objects, features, aspects, and advantages of this disclosure will become more apparent from the following detailed description and the accompanying drawings.

### BRIEF DESCRIPTION OF THE DRAWINGS

FIG. 1 is a side view illustrating an electric passenger transport vehicle.

FIG. 2 is a diagram illustrating a plane layout of batteries.

FIG. 3 is a side view illustrating the battery, a support frame, and a first seat.

FIG. 4 is a perspective view illustrating the batteries and the support frame.

### DESCRIPTION OF THE PREFERRED EMBODIMENTS

### Embodiment

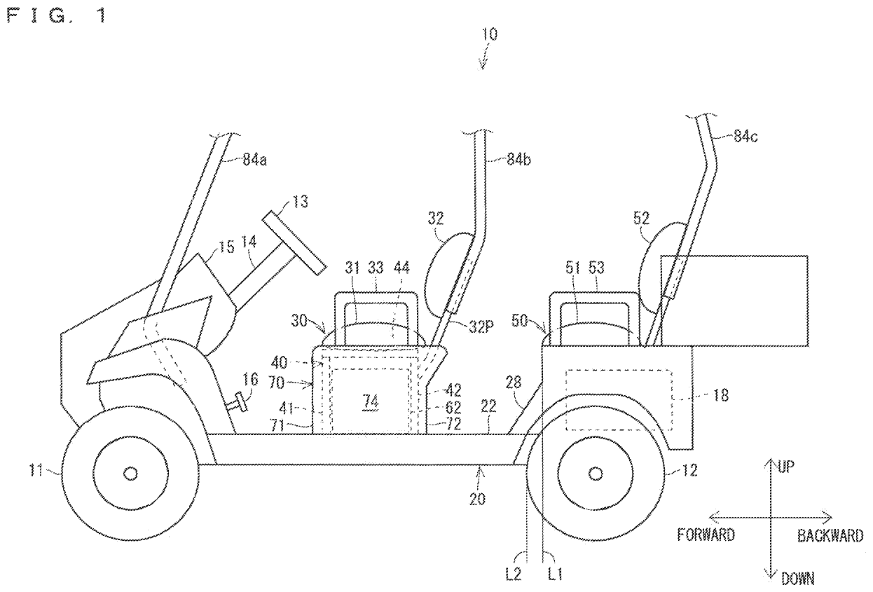

An electric passenger transport vehicle according to an embodiment will be hereinafter described. FIG. 1 is a side view illustrating an electric passenger transport vehicle 10.

Here, the electric passenger transport vehicle is an electric vehicle designed to travel at low speeds within a limited area.

The electric passenger transport vehicle may be an electric off-road vehicle. The electric off-road vehicle is an electric versatile small vehicle suitable for off-road travel rather than for fast travel on a public road.

The electric off-road vehicle may be an electric side-by-side vehicle, for example.

The electric side-by-side vehicle is a small electric vehicle suitable for all terrain travel, and is a vehicle that occupants can be seated side by side, for example. The electric side-by-side vehicle may be a multipurpose off-highway utility vehicle (MOHUV) defined by ANSI/OPEI B71.9-2016 or a recreational off-highway vehicle defined by ANSI/ROHVA 1-2016 and powered by an electric motor.

Examples of the limited area may include limited community areas, private roads, and private lands (e.g., golf courses and parks). The limited community areas are areas provided for use by community residents. The community areas are areas including, for example, houses and public facilities (e.g., schools and hospitals), and are areas in which electric passenger transport vehicles designed to travel through non-public highways are permitted to travel at low speeds. The low speeds are, for example, speeds with upper limits ranging from 20 mph to 30 mph. The electric passenger transport vehicles include electric vehicles among vehicles in accordance with ANSI/ILTVA Z135, and electric vehicles among golf carts in accordance with ANSI/ILTVA Z130.1. Furthermore, the electric passenger transport vehicles include personal transportation electric vehicles. Since the personal transportation electric vehicles are electric vehicles designed to travel through private roads that are non-public highways or through private lands at low speeds, these electric vehicles may have open right and left passenger entrances to seats without being obstructed by walls or doors to facilitate loading or unloading passengers. Here, the passengers can walk past in a lateral direction without being obstructed by doors or walls.

An electric passenger transport vehicle 10 includes a car body 20, a first seat 30, a second seat 50, and batteries 60. In the following description, traveling directions of the electric passenger transport vehicle 10 may be expressed as forward, backward opposite to the forward direction, downward toward road surfaces on which the electric passenger transport vehicle 10 travels, and upward opposite to the downward direction. The right and left may be referred to while a person stands on a road surface and faces forward. The right-left direction is a vehicle-width direction.

The car body 20 includes a floor 22. The floor 22 is located at the bottom of loading space for passengers. The floor 22 is a portion including a surface which supports the feet of a passenger during traveling or on which the feet are placed for movement of the passenger who is getting on or off. Furthermore, the floor 22 is a portion that supports the first seat and the batteries 60.

The floor 22 may be a floor plate supported in a horizontal state by a car body frame, or a combination portion of the car body frame and the floor plate. The car body may have a monocoque structure. In such a case, the floor is a portion located at the bottom of the loading space for passengers, the first seat, and the batteries in the car body with the monocoque structure.

The electric passenger transport vehicle 10 further includes front wheels 11 and rear wheels 12.

For example, the two front wheels 11 are supported to be rotatable to front, right, and left portions of the car body 20. The front wheels 11 are located, for example, in front of the floor 22. The front wheels 11 may be supported to be rotatable around a vertical direction or a steering axis tilt in the vertical direction. The number of the front wheels 11 may be one.

A steering wheel 13 is located behind the front wheels 11. The steering wheel 13 is supported to be rotatable by a steering shaft 14. The steering wheel 13 is located closer to the front above the floor 22. The steering wheel 13 is located closer to the front than the first seat 30. The steering shaft is coupled to the front wheels 11 through, for example, a steering gear. The front wheels 11 are rotated around the steering axis, according to an operation of the steering wheel 13. The rotation of the front wheels 11 around the steering axis changes a traveling direction of the electric passenger transport vehicle 10.

A speed indicator and an instrument panel 15 displaying, for example, a remaining quantity of batteries may be disposed in front of the steering wheel 13. Operation pedals 16 may be disposed below the steering wheel 13. The operation pedals 16 are, for example, a brake pedal and an accelerator pedal.

For example, the two rear wheels 12 are supported to be rotatable to rear, right, and left portions of the car body 20. The electric passenger transport vehicle 10 includes an electric motor 18 for traveling. A rotating shaft of the electric motor is coupled to a shaft of the rear wheels 12 directly or through a gear. Transmission of rotation drive force of the electric motor to the rear wheels 12 enables the electric passenger transport vehicle 10 to travel. The electric motor 18 may be located, for example, below the second seat 50. The electric motor 18 may be located between the two rear wheels 12.

The first seat 30 is a seat located at a distance above the floor 22. In this embodiment, the first seat 30 is a front seat to be seated by a driver. The first seat 30 is located more backward than the steering wheel 13. The driver seated on the first seat 30 can operate the steering wheel 13. The first seat 30 may have a width that can accommodate 5 another passenger to be seated next to the driver. In this embodiment, the first seat 30 has a width that can accommodate two passengers including the driver.

The first seat 30 includes, for example, a seat portion 31 and a back rest portion 32. The first seat 30 is supported above the floor 22 by, for example, a support frame 40 protruding upward from the floor 22. A seating surface of the seat portion 31 faces upward. The back rest portion 32 is located behind and above the seat portion 31. The back of the passenger seated on the seat portion 31 is supported by the back rest portion 32 from behind. The first seat 30 may have armrests 33 for supporting the elbows of the passenger seated.

The second seat 50 is a seat located at a distance behind the first seat 30. The second seat 50 includes, for example, a seat portion 51 and a back rest portion 52. The second seat 50 is supported above the floor 22 by, for example, a support frame that stands erect between the two rear wheels 12 in the car body 20. A seating surface of the seat portion 51 faces upward. The back rest portion 52 is located behind and above the seat portion 51. The back of the passenger seated on the seat portion 51 is supported by the back rest portion 52 from behind. The second seat 50 may have armrests 53 for supporting the elbows of the passenger seated.

Space that can accommodate the legs of a person, for example, space approximately 15 cm or more in length may be provided between the first seat 30 and the second seat 50. A front end of the second seat 50 may be located more backward than a front end of the rear wheels 12. The front end of the second seat 50 is a portion at the most forward position of the second seat 50 when viewed along the lateral direction. The front end of the second seat 50 is a front edge of the seat portion 51 in this embodiment (see a line L1). The front end of the rear wheels 12 is a portion at the most forward position of the rear wheels 12 when viewed along the lateral direction (see a line L2). The second seat 50 may have the armrests 53 for supporting the elbows of the passenger seated.

The electric passenger transport vehicle 10 may include pillar frames 84a, 84b, and 84c.

In this embodiment, the pillar frames 84a, 84b, and 84c include the front pillar frames 84a, the middle pillar frames 84b, and the rear pillar frames 84c. The front pillar frames 84a extend from right and left portions in front of the first seat 30 toward upward in the car body 20. The middle pillar frames 84b extend from the first seat 30, that is, from the back rest portion 32 of the first seat 30 in this embodiment toward upward. The middle pillar frames 84b may extend from an outward lateral portion of the seat portion 31 of the first seat 30 toward upward. The middle pillar frames 84b may be supported by the floor 22. The rear pillar frames 84c extend from the second seat 50, that is, from the back rest portion 52 of the second seat 50 in this embodiment toward upward.

The electric passenger transport vehicle 10 does not include a body covering the lateral portions of the car body 20. As described above, the pillar frames 84a, 84b, and 84c are not located at outside portions of the space between the first seat 30 and the second seat 50 in the vehicle-width direction. Thus, a passenger entrance 28 is open at the outside portions of the space between the first seat 30 and the second seat 50 in the vehicle-width direction on a permanent basis. Thus, the passenger getting on or off the second seat 50 can get on from one of right and left sides of the passenger entrance 28, and get off from the other of the right and left sides of the passenger entrance 28 through the space between the first seat 30 and the second seat 50.

The passenger entrance 28 being open on a permanent basis means that the passenger entrance 28 is open without being obstructed by doors or walls that prevent the passenger from getting on or off. Thus, the passenger entrance 28 may be covered with, for example, a flexible sheet for rain guard.

The number of the pillar frames 84a, 84b, and 84c is any. For example, the middle pillar frames 84b may be omitted.

The batteries 60 are, for example, batteries for rotationally driving the electric motor 18 for traveling.

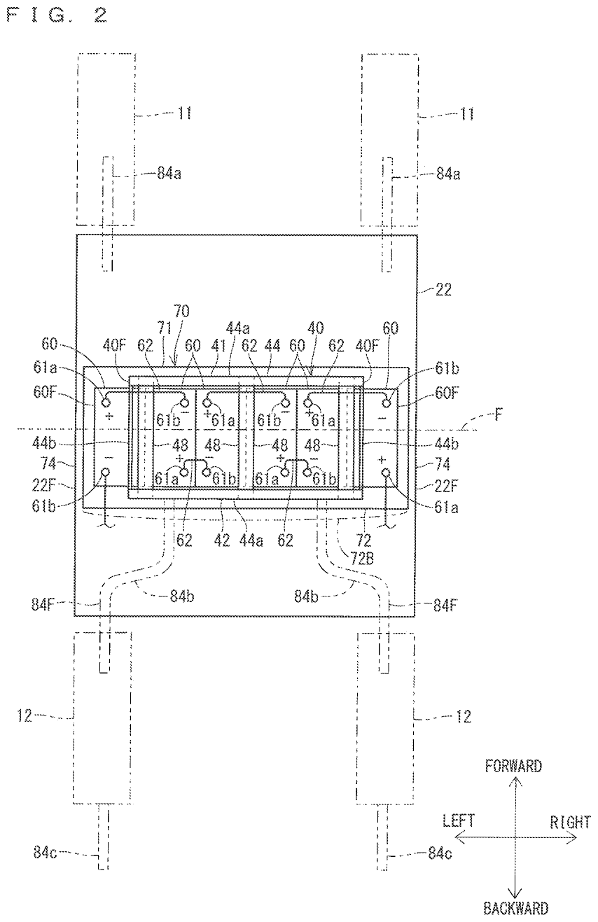

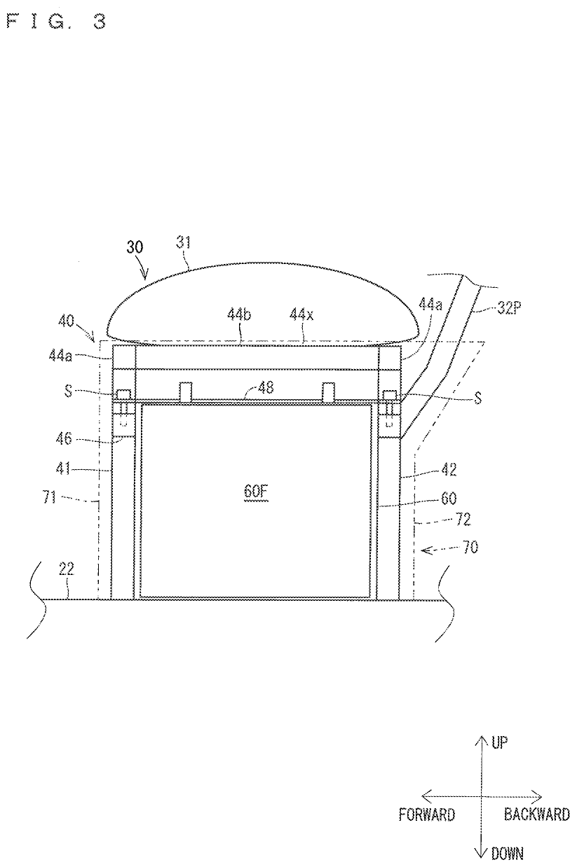

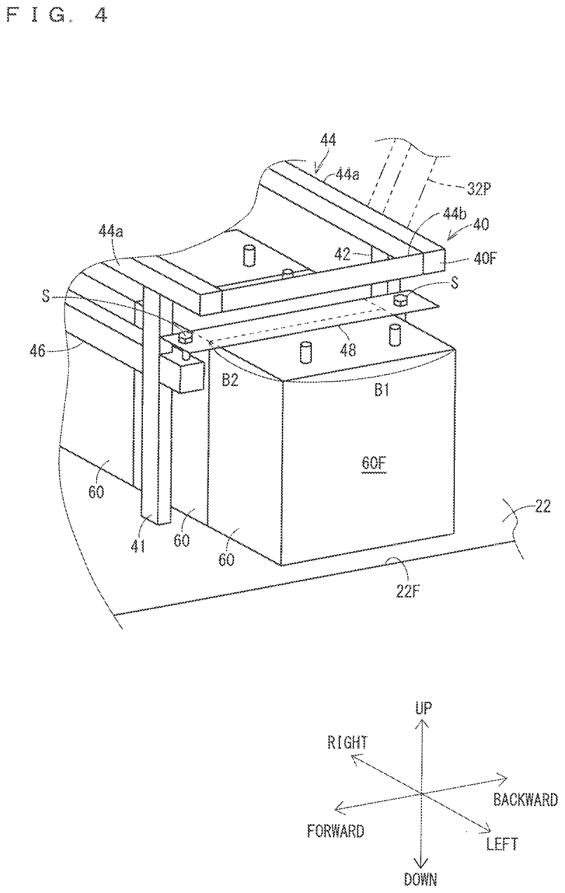

The layout of the batteries 60 in the electric passenger transport vehicle 10 will be described. FIG. 2 is a diagram illustrating the layout of the batteries 60. FIG. 2 illustrates the support frame 40 supporting the first seat 30, a cover 70 covering the batteries 60, and the floor 22. FIG. 2 also illustrates, using two-dot chain lines, the positions of the front wheels 11, the rear wheels 12, and the pillar frames 84a, 84b, and 84c. FIG. 3 is a side view illustrating the battery 60, the support frame 40, and the first seat 30. FIG. 3 illustrates the cover 70 using a two-dot chain line. FIG. 4 is a perspective view illustrating the batteries 60 and the support frame 40.

As illustrated in FIGS. 2 to 4, the batteries 60 are aligned in the vehicle-width direction between the first seat 30 and the floor 22. Locating the batteries 60 between the first seat 30 and the floor 22 means locating at least a part of the batteries 60 between the first seat 30 and the floor 22 in the forward and backward direction. Thus, the batteries 60 may partly extend off forward and backward from the first seat 30. All the batteries 60 may be located between the first seat 30 and the floor 22.

The batteries 60 may be located more forward than the back end of the seat portion 31. This easily widens the leg space for the second seat 50. As described in this embodiment, the batteries 60 may, for example, fit between the front and back ends of the seat portion 31 and between the right and left ends of the seat portion 31 in a plan view.

All the batteries 60 are disposed in at least a partially overlapping relationship when viewed from a side along the vehicle-width direction. In this embodiment, all the batteries 60 are batteries of the same size. All the batteries 60 are disposed in a completely overlapping relationship when viewed from the side along the vehicle-width direction. A part of the batteries may protrude forward or backward from the rest thereof, without being limited to the aforementioned examples. Furthermore, a part of the batteries 60 may protrude upward or downward from the rest thereof.

The batteries 60 may be any batteries that can store electric energy, and are not particularly limited by a mechanism for storing the electric energy. The batteries 60 may be, for example, lead-acid batteries, lithium-ion batteries, or nickel hydrogen storage batteries. In this embodiment, the batteries 60 are lead-acid batteries.

An output voltage of the battery 60 is not particularly limited. The output voltage of the battery 60 may be, for example, 8 V, 12 V, or 24 V. In this embodiment, the output voltage of the battery 60 is 8 V as one example.

The size of the battery 60 is not particularly limited. The battery 60 may have a shape of a rectangle enclosed by a pair of long sides with a first dimension B1 and a pair of short sides with a second dimension B2 shorter than the first dimension B1 in a plan view (see FIG. 4). In this embodiment, the battery 60 is a rectangular parallelepiped, and may have, for example, 260 mm as the first dimension B1, 180 mm as the second dimension B2, and 283 mm as a height.

Although the number of the batteries 60 is not particularly limited, this embodiment describes an example where the number of the batteries 60 is six. Obviously, the number of the batteries 60 is any, and may be, for example, 5 or less, or 7 or more.

Attitudes of the batteries 60 are any. In this embodiment, the batteries 60 are aligned in the vehicle-width direction in attitudes in which a direction of the short sides with the second dimension B2 is aligned with the vehicle-width direction. Since the direction of the short sides is aligned with the vehicle-width direction, the batteries 60 as many as possible are disposed within the vehicle width range.

The surfaces of the batteries 60 facing the second seat 50 may be aligned at the same position in the forward and backward direction. Specifically, the surfaces of the batteries 60 facing the legs of the passenger who is to be seated on the second seat 50 may be aligned at the same position in the forward and backward direction. Here, the surfaces of the batteries 60 facing the second seat 50 are located on the plane along the vertical direction and the lateral direction.

Assume that a part of the batteries protrudes backward partly from the rest thereof. Then, assume that the batteries are covered with a cover. Partly protruding backward a part of the cover covering the battery portion protruding backward, from the other portions presumably obstructs the smooth movement of the legs. Setting the entire cover to match the position of the battery portion protruding backward narrows the entire leg space for the second seat 50. Aligning the surfaces of the batteries 60 facing the second seat 50 at the same position in the forward and backward direction widens the entire leg space for the second seat 50, and provides the space allowing the smooth movement of the legs.

The batteries 60 may be connected in series or in parallel with each other. In this embodiment, the batteries 60 are, for example, connected in series with each other. When the six batteries 60 each with the output voltage of 8V are connected in series with each other, an output voltage of 48V is applicable to the electric motor 18 or a driving circuit of the electric motor 18.

The batteries 60 may be disposed in the following manner so that the adjacent batteries 60 are connected through a cable as short as possible.

Specifically, each of the batteries 60 includes a positive terminal 61a and a negative terminal 61b that are aligned along a direction of the long sides with the first dimension B1 on a surface facing upward. The positive terminal 61a and the negative terminal 61b are closer to one of the long sides with respect to the direction of the short sides with the second dimension B2. In the direction of the long sides with the first dimension B1, the positive terminal 61a is closer to one of the short sides, and the negative terminal 61b is closer to the other short side.

The positive terminal 61a and the negative terminal 61b in the adjacent batteries 60 are disposed side by side in the vehicle-width direction. Specifically, the batteries 60 are disposed so that respective orientations in the direction of the long sides are alternated in the vehicle-width direction. Thus, cables 62 through which the batteries 60 are connected in series with each other are disposed along the vehicle-width direction, and can connect, in the vehicle-width direction, the positive terminals 61a and the negative terminals 61b that are adjacent to each other.

This can shorten the cables 62 more than cables through which terminals disposed at different positions are connected in the forward and backward direction. Furthermore, since the cables 62 need not be disposed diagonally, the connection operations are easily and accurately performed.

The first seat 30 is supported by the support frame 40 on the floor 22. The positional relationship between the support frame 40 and the batteries 60 will be described.

The support frame 40 includes front columns 41, rear columns 42, and a square frame 44.

The front columns 41 protrude upward from the floor 22 in front of the batteries 60. Thus, the batteries 60 are located more backward than the front columns 41. Upper ends of the front columns 41 are located above the batteries 60. The two front columns 41 protrude upward from the floor 22 in this embodiment.

The rear columns 42 protrude upward from the floor 22 behind the batteries 60. Thus, the batteries 60 are located more forward than the rear columns 42. Upper ends of the rear columns 42 are located above the batteries 60. The two rear columns 42 protrude upward from the floor 22 in this embodiment. The front columns 41 may be the same as the rear columns 42 in length. The front columns 41 may be the same as the rear columns 42 in position in the vehicle-width direction.

The square frame 44 is a square frame obtained by combining, in a square shape, two horizontal frames 44a along the vehicle-width direction and two vertical frames 44b along the forward and backward direction. The horizontal frames 44a may be coupled to the vertical frames 44b by, for example, screwing or welding. A vertical frame, a horizontal frame, or a diagonal frame may be added to the square frame 44.

Each of the two horizontal frames 44a is set to a length shorter than a lateral width of the floor 22. Each of the two horizontal frames 44a is set to a length larger than a width of the middle batteries 60 (four batteries herein) except the batteries 60 at the right and left ends from among the batteries 60 aligned in the vehicle-width direction. Each of the two vertical frames 44b is set to the size exceeding the length of the battery 60 in the forward and backward direction. Each of the two vertical frames 44b is set to, for example, the size corresponding to the forward and backward positions of the front columns 41 and the rear columns 42.

The front horizontal frame 44a is disposed on the front columns 41. The upper ends of the front columns 41 are coupled to the front horizontal frame 44a at positions at a distance above the floor 22 by, for example, screwing or welding. The rear horizontal frame 44a is disposed on the rear columns 42. The upper ends of the rear columns 42 are coupled to the rear horizontal frame 44a at positions at a distance above the floor 22 by, for example, screwing or welding. Since the upper ends of the front columns 41 and the rear columns 42 are located above the batteries 60, the square frame 44 is located at a distance above the floor 22 and supported at a position at a distance above the upper surface of the batteries 60.

Furthermore, the length of each of the horizontal frames 44a may be set to exceed the spacing between the two front columns 41 and the spacing between the two rear columns 42. Here, the spacing between the two front columns 41 and the two rear columns 42 support the horizontal frames 44a at positions closer to the middle of the horizontal frames 44a than to the right and left ends thereof.

The seat portion 31 is formed into a flat shape spreading as large as the square frame 44 or larger than the square frame 44 in a plan view. The seat portion 31 placed on the square frame 44 can cover the batteries 60 from above. The seat portion 31 may be just placed on the square frame 44, or fixed to the square frame 44 by, for example, screwing or using a fitting structure to prevent its drop.

The square frame 44 is covered with a cover made of a resin or a metal, and the seat portion 31 may be disposed on the cover made of the resin or the metal.

Directly or indirectly disposing the seat portion 31 on the square frame 44 supports the first seat 30 including the seat portion 31 at a position at a distance above the floor 22. In this state, the front columns 41 support a front portion of the seat portion 31 at the positions at a distance above the floor 22. The rear columns 42 support a rear portion of the seat portion 31 at the positions at a distance above the floor 22. The support frame 40 need not include both of the front columns 41 and the rear columns 42. For example, the front columns or the rear columns in the support frame may support the seat portion in a cantilevered manner. A column located in the middle of the seat portion in the forward and backward direction in the support frame may support the seat portion.

Outer faces 60F located at the extreme ends of the batteries 60 in the vehicle-width direction are outside right and left ends 40F of the support frame 40, and are inside right and left ends 22F of the floor 22. The outer faces 60f located at the extreme ends of the batteries 60 in the vehicle-width direction are a right face of the battery 60 at the extreme right position and a left face of the battery 60 at the extreme left position in the vehicle-width direction. The left ends 40F of the support frame 40 are a portion at the extreme right position and a portion at the extreme left position of the support frame 40, and are both end faces of the horizontal frames 44a or outward faces of the two vertical frames 44b in this embodiment. The right and left ends 22F of the floor 22 are edges at the extreme right position or at the extreme left position in the forward and backward direction of a region where the batteries 60 are disposed in the floor 22.

Locating the batteries 60 outside the right and left ends 40F of the support frame 40 and inside the right and left ends 22F of the floor 22 disposes the batteries 60 over a region into which a support structure of the seat portion 31 extends and within a range of the lateral width of the floor 22.

A spacing between each of the right and left ends 22F that are side edges of the floor 22 and a corresponding one of the outer faces 60F of the batteries 60 in a plan view may be 10 cm or less. Reducing the spacing between each of the right and left ends 22F of the floor 22 and a corresponding one of the outer faces 60F of the batteries 60 to 10 cm or less enables the batteries 60 to be efficiently disposed between the leg space for the first seat 30 and the leg space for the second seat 50.

The support frame 40 includes additional horizontal frames 46 in this embodiment. Here, the two additional horizontal frames 46 are disposed below the two horizontal frames 44a. The front additional horizontal frame 46 is coupled to the two horizontal frames 44a below the front horizontal frame 44a by, for example, screwing or welding. The back additional horizontal frame 46 is coupled to the two horizontal frames 44a below the rear horizontal frame 44a by, for example, screwing or welding. The additional horizontal frames 46 increase the rigidity of the support frame 40, and firmly support the first seat 30. The additional horizontal frames 46 may be omitted.

The support frame 40 may support battery holding components 48. The battery holding components 48 are elongated components extending in the forward and backward direction along the boundaries of the adjacent batteries 60. The battery holding components 48 may be long and narrow plate components. Each of the battery holding components 48 is set to a length enough to reach front additional horizontal frame 46 and back additional horizontal frame 46. Front ends of the battery holding components 48 are fixed to the front additional horizontal frame 46 by, for example, screws S. Back ends of the battery holding components 48 are fixed to the back additional horizontal frame 46 by, for example, screws S. A middle portion of each of the battery holding components 48 is in contact with edges of the adjacent batteries 60 that are adjacent to a boundary between the batteries 60, at the boundary on the surface of the battery 60 facing upward, and restricts the upward movement of the batteries 60. The battery holding components 48 may press the batteries 60 toward the floor 22, so that the batteries 60 may be supported by being sandwiched between the floor 22 and the battery holding components 48.

When the batteries 60 are replaced, the battery holding components 48 should be temporarily removed from the additional horizontal frames 46 by loosening the screws S.

The battery holding components 48 may be supported by the square frame 44, the front columns 41, or the rear columns 42. The battery holding components 48 may be located at all the boundaries between the adjacent batteries 60, or located at alternate ones of the boundaries.

In this embodiment, the batteries 60 and the support frame 40 are covered with the cover 70. A positional relationship between the cover 70 and the batteries 60 will be described.

The cover 70, for example, covers the batteries 60 and the support frame 40 from side to side and forward and backward. In this embodiment, the cover 70 includes a front cover 71, a rear cover 72, and right and left lateral covers 74. The front cover 71, the rear cover 72, and the right and left lateral covers 74 may be an integrally-molded component, or a component obtained by combining separately manufactured components. The cover 70 may be made of a resin or a metal. In this embodiment, the cover 70 is a resin component integrally molded by a die using the same resin.

The front cover 71 is formed into a plate covering the batteries 60 and the support frame 40 from the front. The leg space for the first seat 30 extends in front of the front cover 71.

The rear cover 72 is formed into a plate covering the batteries 60 and the support frame 40 from the rear. The leg space for the second seat 50 extends behind the rear cover 72.

The front cover 71 covering the batteries 60 and the support frame 40 from the front easily reduces partial protrusions of the front columns 41. The rear cover 72 covering the batteries 60 and the support frame 40 from the rear easily reduces partial protrusions of the rear columns 42. Specifically, with respect to the batteries 60 aligned in the vehicle-width direction, the front columns 41 are partially located in the vehicle-width direction, and the rear columns 42 are partially located in the vehicle-width direction. Thus, the front columns 41 or the rear columns 42 may become obstructions for the legs that move through the leg space for the first seat 30 or the leg space for the second seat 50. Thus, the front cover 71 or the rear cover 72 covering the batteries 60 together with the columns 41 and 42 from the front or the rear easily reduces partial protrusions of the columns 41 or 42. Thus, the columns 41 and 42 hardly become obstructions for the legs that move through the leg space.

Particularly, when the rear cover 72 is flat-plate-shaped, an external surface of the rear cover 72 hardly becomes an obstruction for the legs that move through the leg space. When the rear cover 72 has a curved plate shape protruding toward the second seat 50 in a plan view, the external surface of the rear cover 72 hardly becomes an obstruction for the legs that move through the leg space (see a rear cover 72B indicated by a two-dot chain line in FIG. 2).

The rear cover 72 is a portion in contact with toes of the foot placed in the leg space, for example, a portion within 20 cm upward from the floor 22. A portion above the rear cover 72 need not be flat-plate-shaped or have a curved plate shape.

A middle portion of the rear horizontal frame 44a is supported by a column 32P supporting the back rest portion 32 in this embodiment. The column 32P extends diagonally upward from the horizontal frame 44a. A portion of the cover 70 which covers the column 32P may be a portion partially swelling diagonally upward along the extension direction of the column 32P.

The outer faces 60F of the batteries 60 may be located outside right and left ends 84F of the pillar frames 84a, 84b, and 84c. This disposes the batteries 60 in a wide region in the vehicle-width direction. The right and left ends 84F of the pillar frames 84a, 84b, and 84c are the most outside portions in the pillar frames 84a, 84b, and 84c in the vehicle-width direction.

Assuming that there is an imaginary plane F passing through the center of the front wheels 11 and the rear wheels 12 in the forward and backward direction, the imaginary plane F may cross all the batteries 60. The center of the front wheels 11 and the rear wheels 12 in the forward and backward direction is, for example, a center line of the central axes of the front wheels 11 and the rear wheels 12 in a straight-ahead driving state. The imaginary plane F is an imaginary plane passing through the center line and along the vertical direction.

The batteries 60 are heavy loads. It is assumed that a weight ratio of the batteries 60 to the total weight of the electric passenger transport vehicle 10 tends to be larger. The center of gravity of the vehicle easily approximates to the center of the front wheels 11 and the rear wheels 12 by making the imaginary plane F cross all the batteries 60.

In the electric passenger transport vehicle 10 with the aforementioned structure, all the batteries 60 are aligned in the vehicle-width direction so that they at least partially overlap one another when viewed from the side along the vehicle-width direction. Thus, a longitudinal length of the space in which the batteries 60 are disposed is shorter than that when the batteries 60 are aligned in the forward and backward direction. This easily reserves the wide leg spaces in front of and behind the batteries 60.

This also easily aligns the rear surfaces of the batteries 60 in position while disposing the batteries 60 under the first seat 30 and preventing the batteries 60 from protruding outside the floor 22 in the vehicle-width direction. For example, the surfaces of the batteries 60 facing the second seat 50 can be aligned at the same position in the forward and backward direction. This can provide the passenger to be seated on the second seat 50 with the leg space with less protrusions or depressions in the forward and backward direction. This contributes to improvement of the comfort of the passenger to be seated on the second seat 50.

Since the batteries 60 are located more forward than the back end of the seat portion 31, the passenger to be seated on the second seat 50 is easily provided with the leg space wider in the forward and backward direction in this respect.

Furthermore, the batteries 60 are located more forward than the rear columns 42. Consequently, the batteries 60 hardly extend off from the support frame 40 supporting the first seat 30, toward the second seat 50. In this respect, the passenger to be seated on the second seat 50 is also easily provided with the leg space wider in the forward and backward direction.

Furthermore, the rear cover 72 covers the batteries 60 and the rear columns 42 from the rear. Thus, even when the rear columns 42 are partially located in the vehicle-width direction with respect to the batteries 60, the rear cover 72 can reduce the partial protrusions of the rear columns 42. This can provide the passenger on the second seat 50 with the leg space with less protrusions or depressions in the forward and backward direction.

Particularly, when the rear cover 72 is flat-plate-shaped or has a curved plate shape protruding toward the second seat 50, the legs of the passenger to be seated on the second seat 50 are less entangled with the rear cover than a rear cover formed into a protrusion corresponding to the rear columns protruding toward the rear.

When the batteries 60 are located more backward than the front columns 41, the batteries 60 hardly extend off in front of the first seat 30. Accordingly, the passenger to be seated on the first seat 30 is easily provided with the leg space wider in the forward and backward direction.

Here, even when the front columns 41 are partially located in the vehicle-width direction with respect to the batteries 60, the front cover 71 covering the batteries 60 and the front columns 41 from the front can reduce the partial protrusions of the front columns 41. This provides the passenger on the first seat 30 with the leg space with less protrusions or depressions in the forward and backward direction. The front cover 71 may be flat-plate-shaped or have a curved plate shape protruding toward the front, similarly to the rear cover 72.

Furthermore, aligning the batteries 60 in the vehicle-width direction in the attitudes in which the short side direction is aligned with the vehicle-width direction easily provides the leg spaces with less protrusions or depressions in front of and behind the batteries 60.

Furthermore, disposing the positive terminal 61a and the negative terminal 61b in the adjacent batteries 60 side by side in the vehicle-width direction connects the positive terminal 61a and the negative terminal 61b in the adjacent batteries 60 through a cable as short as possible.

Furthermore, when the batteries 60 are lead-acid batteries, the lead-acid batteries that are easily upsized are efficiently disposed between the floor 22 and the first seat 30.

The electric passenger transport vehicle 10 includes the passenger entrance 28. When the leg space for the second seat 50 is wide, the user of the second seat 50 enters the vehicle through the passenger entrance 28 on one side in the vehicle-width direction, is seated on the second seat 50, and then easily exits outside through the passenger entrance on the other side in the vehicle-width direction. Particularly, aligning the surfaces of the batteries 60 facing backward in the forward and backward direction allows the user of the second seat 50 to easily move in the vehicle-width direction.

Furthermore, locating the front end of the second seat 50 (see L1) more backward than the front end of the rear wheels 12 (see L2) widens between the front and back seats 30 and 50 and easily reserves the leg space.

Furthermore, the battery holding components 48 supported by the support frame 40 can omit or simplify components restricting the movement of the batteries 60.

Locating the outer faces 60F at the extreme ends of the batteries 60 in the vehicle-width direction outside the right and left ends 40F of the support frame 40 and inside the right and left ends 22F of the floor 22 allows efficient use of the space width between the first seat 30 and the second seat 50.

Furthermore, locating the outer faces 60F of the batteries 60 outside the right and left ends 84F of the pillar frames 84a, 84b, and 84c and inside the right and left ends of the floor 22 allows efficient use of the space width between the first seat 30 and the second seat 50.

Furthermore, the center of gravity easily approximates to the center of the front wheels 11 and the rear wheels 12 in the forward and backward direction by making the imaginary plane F passing through the center of the front wheels 11 and the rear wheels 12 in the forward and backward direction cross all the batteries 60.

The electric passenger transport vehicle may have seats in three or more rows. In this case, a seat in the second or subsequent rows may be the first seat, and a seat behind the first seat in the second or subsequent rows may be the second seat. Here, the batteries may be located between the first seat in the second or subsequent rows and the floor.

This application discloses the following aspects.

A first aspect is an electric passenger transport vehicle including: a car body including a floor; a first seat located at a distance above the floor; a second seat located at a distance behind the first seat; and batteries aligned between the first seat and the floor in a vehicle-width direction, all the batteries at least partially overlapping one another when viewed from a side along the vehicle-width direction.

The wide leg space is easily reserved in this electric passenger transport vehicle.

A second aspect is the electric passenger transport vehicle according to the first aspect, wherein surfaces of the batteries facing the second seat are aligned at the same position in a forward and backward direction.

In this case, the surfaces of the batteries facing the second seat are aligned at the same position in the forward and backward direction, in front of the second seat. This can provide the passenger to be seated on the second seat with the leg space with less protrusions or depressions in the forward and backward direction. This contributes to improvement of the comfort of the passenger to be seated on the second seat.

A third aspect is the electric passenger transport vehicle according to the first or second aspect, wherein the first seat includes a seat portion and a back rest portion, and the batteries are located more forward than a back end of the seat portion.

According to the second aspect, this can provide the passenger to be seated on the second seat with the leg space wider in the forward and backward direction.

A fourth aspect is the electric passenger transport vehicle according to one of the first to the third aspects, wherein the first seat includes a seat portion and a back rest portion, and the electric passenger transport vehicle further includes rear columns supporting a rear portion of the seat portion at positions at a distance above the floor, and the batteries are located more forward than the rear columns.

Consequently, the batteries hardly extend off toward the second seat. Thus, the passenger to be seated on the second seat is also easily provided with the leg space wider in the forward and backward direction.

A fifth aspect is the electric passenger transport vehicle according to the fourth aspect further including a rear cover covering the batteries and the rear columns from rear.

Thus, even when the rear columns are partially located in the vehicle-width direction with respect to the batteries, the rear cover covering the batteries and the rear columns from the rear can reduce the partial protrusions of the rear columns. This can provide the passenger on the second seat with the leg space with less protrusions or depressions in the forward and backward direction.

A sixth aspect is the electric passenger transport vehicle according to the fifth aspect, wherein the rear cover is flat-plate-shaped or has a curved plate shape protruding toward the second seat.

This hardly entangles the legs of the passenger to be seated on the second seat.

A seventh aspect is the electric passenger transport vehicle according to one of the first to the sixth aspects, wherein the first seat includes a seat portion and a back rest portion, the electric passenger transport vehicle further includes front columns supporting a front portion of the seat portion at positions at a distance above the floor, and the batteries are located more backward than the front columns.

Consequently, the batteries hardly extend off in front of the first seat. Thus, the passenger to be seated on the first seat is easily provided with the leg space wider in the forward and backward direction.

An eighth aspect is the electric passenger transport vehicle according to the seventh aspect further including a front cover covering the batteries and the front columns from front.

Thus, even when the front columns are partially located in the vehicle-width direction with respect to the batteries, the front cover covering the batteries and the front columns from the front can reduce the partial protrusions of the front columns. This can provide the passenger on the first seat with the leg space with less protrusions or depressions in the forward and backward direction.

A ninth aspect is the electric passenger transport vehicle according to one of the first to the eighth aspects, wherein each of the batteries has a shape of a rectangle enclosed by a pair of long sides with a first dimension and a pair of short sides with a second dimension smaller than the first dimension in a plan view, and the batteries are aligned in the vehicle-width direction in attitudes in which a direction of the short sides is aligned with the vehicle-width direction.

This easily provides the leg spaces with less protrusions or depressions in front of and behind the batteries.

A tenth aspect is the electric passenger transport vehicle according to one of the first to the ninth aspects, wherein each of the batteries includes a positive terminal and a negative terminal that are aligned along a forward and backward direction, and the positive terminal and the negative terminal in the adjacent batteries are disposed side by side in the vehicle-width direction.

This connects the positive terminal and the negative terminal in the adjacent batteries through a cable as short as possible.

An eleventh aspect is the electric passenger transport vehicle according to one of the first to the tenth aspects, wherein each of the batteries is a lead-acid battery.

In this case, the lead acid batteries that are easily upsized can be efficiently disposed between the floor and the first seat.

A twelfth aspect is the electric passenger transport vehicle according to one of the first to the eleventh aspects, wherein a passenger entrance is open at outside portions of space between the first seat and the second seat in the vehicle-width direction on a permanent basis.

When the leg space is wide, the user of the second seat enters the vehicle through the passenger entrance on one side in the vehicle-width direction, is seated on the second seat, and then easily exits outside through the passenger entrance on the other side in the vehicle-width direction.

A thirteenth aspect is the electric passenger transport vehicle according to one of the first to the twelfth aspects further including a front wheel and rear wheels, wherein a front end of the second seat may be located more backward than a front end of the rear wheels.

This widens between the front and back seats and easily reserves the leg space.

A fourteenth aspect is the electric passenger transport vehicle according to one of the first to the thirteenth aspects, wherein the first seat includes a seat portion, the electric passenger transport vehicle further includes a support frame supporting the seat portion at a position at a distance above the floor, and the support frame supports battery holding components that restrict upward movement of the batteries.

This can omit or simplify components restricting the movement of the batteries.

A fifteenth aspect is the electric passenger transport vehicle according to one of the first to the fourteenth aspects further including a support frame supporting a seat portion at a position at a distance above the floor, wherein outer faces located at extreme ends of the batteries in the vehicle-width direction are located outside right and left ends of the support frame and inside right and left ends of the floor.

This allows efficient use of the space width between the first seat and the second seat.

A sixteenth aspect is the electric passenger transport vehicle according to one of the first to the fifteenth aspects further including pillar frames, wherein outer faces located at extreme ends of the batteries in the vehicle-width direction are located outside right and left ends of the pillar frames and inside right and left ends of the floor.

This allows efficient use of the space width between the first seat and the second seat.

A seventeenth aspect is the electric passenger transport vehicle according to one of the first to the sixteenth aspects further including a front wheel and rear wheels, wherein an imaginary plane passing through a center of the front wheel and the rear wheels in a forward and backward direction crosses all the batteries.

Consequently, the center of gravity easily approximates to the center of the front wheels and the rear wheels in the forward and backward direction.

The foregoing description is in all aspects illustrative and does not restrict the present invention. Numerous modifications and variations that have not yet been exemplified are devised without departing from the scope of the present invention.

What is claimed is:

1. An electric passenger transport vehicle, comprising:
a car body including a floor;
a first seat located at a distance above the floor;
a second seat located at a distance behind the first seat; and
batteries aligned between the first seat and the floor in a vehicle-width direction, all the batteries at least partially overlapping one another when viewed from a side along the vehicle-width direction.

2. The electric passenger transport vehicle according to claim 1,
wherein surfaces of the batteries facing the second seat are aligned at a same position in a forward and backward direction.

3. The electric passenger transport vehicle according to claim 1,
wherein the first seat includes a seat portion and a back rest portion, and
the batteries are located more forward than a back end of the seat portion.

4. The electric passenger transport vehicle according to claim 1,
wherein the first seat includes a seat portion and a back rest portion, and
the electric passenger transport vehicle further comprises rear columns supporting a rear portion of the seat portion at positions at a distance above the floor, and
the batteries are located more forward than the rear columns.

5. The electric passenger transport vehicle according to claim 4, further comprising
a rear cover covering the batteries and the rear columns from rear.

6. The electric passenger transport vehicle according to claim 5,
wherein the rear cover is flat-plate-shaped or has a curved plate shape protruding toward the second seat.

7. The electric passenger transport vehicle according to claim 1,
wherein the first seat includes a seat portion and a back rest portion,
the electric passenger transport vehicle further comprises front columns supporting a front portion of the seat portion at positions at a distance above the floor, and
the batteries are located more backward than the front columns.

8. The electric passenger transport vehicle according to claim 7, further comprising
a front cover covering the batteries and the front columns from front.

9. The electric passenger transport vehicle according to claim 1,
wherein each of the batteries has a shape of a rectangle enclosed by a pair of long sides with a first dimension and a pair of short sides with a second dimension smaller than the first dimension in a plan view, and
the batteries are aligned in the vehicle-width direction in attitudes in which a direction of the short sides is along the vehicle-width direction.

10. The electric passenger transport vehicle according to claim 1,
wherein each of the batteries includes a positive terminal and a negative terminal that are aligned along a forward and backward direction, and
the positive terminal and the negative terminal in the adjacent batteries are disposed side by side in the vehicle-width direction.

11. The electric passenger transport vehicle according to claim 1,
wherein each of the batteries is a lead-acid battery.

12. The electric passenger transport vehicle according to claim 1,
wherein a passenger entrance is open at outside portions of space between the first seat and the second seat in the vehicle-width direction on a permanent basis.

13. The electric passenger transport vehicle according to claim 1, further comprising
a front wheel and rear wheels,
wherein a front end of the second seat is located more backward than a front end of the rear wheels.

14. The electric passenger transport vehicle according to claim 1,
wherein the first seat includes a seat portion,
the electric passenger transport vehicle further comprises a support frame supporting the seat portion at a position at a distance above the floor, and
the support frame supports battery holding components that restrict upward movement of the batteries.

15. The electric passenger transport vehicle according to claim 1,
wherein the first seat includes a seat portion, and
the electric passenger transport vehicle further comprises a support frame supporting the seat portion at a position at a distance above the floor,
wherein outer faces located at extreme ends of the batteries in the vehicle-width direction are located outside right and left ends of the support frame and inside right and left ends of the floor.

16. The electric passenger transport vehicle according to claim 1, further comprising
pillar frames,
wherein outer faces located at extreme ends of the batteries in the vehicle-width direction are located outside right and left ends of the pillar frames and inside right and left ends of the floor.

17. The electric passenger transport vehicle according to claim 1, further comprising
a front wheel and rear wheels,
wherein an imaginary plane passing through a center of the front wheel and the rear wheels in a forward and backward direction crosses all the batteries.
